(19) United States
(12) Patent Application Publication
(10) Pub. No.: US 2011/0059629 A1
(43) Pub. Date: Mar. 10, 2011

(54) ELECTRICAL CONNECTOR

(76) Inventor: Wan-Tien CHEN, Taipei (TW)

(21) Appl. No.: 12/605,939

(22) Filed: Oct. 26, 2009

(30) Foreign Application Priority Data
Sep. 8, 2009 (TW) 098216542

(51) Int. Cl. H01R 12/04; H01R 24/00

(52) U.S. Cl. 439/64; 439/630

(57) ABSTRACT

The present invention relates to an electrical connector, comprises: an insulation housing; a buckling sheet, an extending sheet is downwardly extended from the buckling sheet, the extending sheet has a buckling hole, at least one end of the extending sheet is installed with a protruding sheet; and a base sheet having a fastening member, a base hole and at least one folded hooking sheet, wherein a limiting sheet is installed in the base hole, the limiting sheet is extended from the bottom end of the base hole and the distal end thereof is in a bended status, when the folded hooking sheet is installed on top of the extending sheet, the limiting sheet is disposed in the buckling hole, and is able to be to finely adjusted according to deformed height of the insulation housing, therefore the electrical connector is able to be stably soldered on an substrate.

### BACKGROUND OF THE INVENTION

1. Field of the Invention

The present invention relates to an electrical connector, more particularly to an electrical connector in which a base sheet is connected to a buckling sheet and the position of the base sheet is able to be longitudinally adjusted so as to be stably soldered on a substrate.

2. Description of Related Art

Packaging methods for memory modules are mostly as followings: single in-line memory module (SIMM) or dual in-line memory module (DIMM); wherein the data bit for the single in-line memory module is 32 bits while the data bit for the dual in-line memory module is 64 bits, so one dual in-line memory module can process data of two single in-line memory modules, therefore the dual in-line memory module is the main stream memory module sector.

For a conventional DIMM electrical connector, an insulation housing is often installed and an insertion slot for receiving a memory module is installed on the insulation housing, the insertion slot is installed with a plurality of first conduction terminals and a plurality of second conduction terminals arranged with an up-down means, and two ends of the insulation housing are respectively installed with a resilient arm having a guiding slot for guiding the electrical card to be inserted in the insertion slot. The insulation housing of the mentioned DIMM electrical connector is made of plastic material and is in an elongated shape, thus high temperature generated during manufacturing or transportation may let said electrical connector deform, so two ends of the insulation housing may have different heights; when the electrical connector, the plural first conduction terminals or the plural second conduction terminals are soldered on a printed circuit board, false soldering may occur due to the height difference, and the quality of electrical connection of the electrical connector will be influenced.

### SUMMARY OF THE INVENTION

One object of the present invention is to provide an electrical connector, in which a base sheet and a buckling sheet can be connected through a buckle point positioning structure, and is adjustable according to deformed height of an insulation housing so as to stably solder the electrical connector on a substrate.

Another object of the present invention is to provide an electrical connector, in which a base sheet and a buckling sheet are connected through a first protruding portion positioning structure and is adjustable according to deformed height of an insulation housing so as to stably solder the electrical connector on a substrate.

One another object of the present invention is to provide an electrical connector, in which a base sheet and a buckling sheet are connected through a reverse covering positioning structure and is adjustable according to deformed height of an insulation housing so as to stably solder the electrical connector on a substrate.

For achieving the objects mentioned above, one solution provided by the present invention is to provide an electrical connector, comprises: an insulation housing having an insertion slot for receiving an electrical card, the insertion slot is installed with a plurality of first conduction terminals and a plurality of second conduction terminals arranged with the first conduction terminals with an up/down means, two ends of the insulation housing are respectively installed with a resilient arm having a guiding slot for guiding the electrical card to be inserted in the insertion slot; a buckling sheet connected to the insulation housing and installed below the resilient arm, an extending sheet is downwardly extended from the buckling sheet, the extending sheet is installed with a buckling hole, and at least one end of the extending sheet is installed with a protruding sheet; and a base sheet having a fastening member, a base hole and at least one folded hooking sheet, wherein the position where the base hole is installed is with respect to the buckling hole, and a limiting sheet is installed in the base hole, when the folded hooking sheet is installed on the extending sheet, the limiting sheet is disposed in the buckling hole and the position of the base sheet is longitudinally adjusted so as to stably solder the fastening sheet on an substrate.

For achieving the objects mentioned above, another solution provided by the present invention is to provide an electrical connector, comprises: an insulation housing having an insertion slot for receiving an electrical card, the insertion slot is installed with a plurality of first conduction terminals and a plurality of second conduction terminals arranged with the first conduction terminals with an up/down means, two ends of the insulation housing are respectively installed with a resilient arm having a guiding slot for guiding the electrical card to be inserted in the insertion slot; a buckling sheet connected to the insulation housing and installed below the resilient arm, an extending sheet is downwardly extended from the buckling sheet, the extending sheet is installed with a first protruding portion, a first concave slot is formed at the back side of the first protruding portion; and a base sheet having a fastening member and a second protruding portion, a second concave slot is formed at the back side of the second protruding portion, wherein the position where the second protruding portion is installed is with respect to the first concave slot, when the second protruding portion is installed in the first concave slot, the position of the base sheet is longitudinally adjusted so as to stably solder the fastening sheet on an substrate.

For achieving the objects mentioned above, one another solution provided by the present invention is to provide an electrical connector, comprises: an insulation housing having an insertion slot for receiving an electrical card, the insertion slot is installed with a plurality of first conduction terminals and a plurality of second conduction terminals arranged with the first conduction terminals with an up/down means, two ends of the insulation housing are respectively installed with a resilient arm having a guiding slot for guiding the electrical card to be inserted in the insertion slot; a buckling sheet connected to the insulation housing and installed below the resilient arm, an extending sheet is downwardly extended from the buckling sheet, at least one end of the extending sheet is installed with a first folded hooking sheet having a sheet gap on the top end; and a base sheet having a fastening member and at least one second folded hooking sheet, wherein the position where the second folded hooking sheet is installed is staggered with respect to the first folded hooking sheet and the orientation thereof is opposite to the first folded hooking sheet, when the second folded hooking sheet is installed in the sheet gap, the position of the base sheet is longitudinally adjusted, and the first folded hooking sheet is reversely covered the base sheet, so the fastening member is stably soldered on an substrate.

### BRIEF DESCRIPTION OF THE DRAWINGS

FIG. 1 is a schematic exploded view of the electrical connector of one preferred embodiment of the present invention;

FIG. 2 is a schematic partially-enlarged view illustrating the buckling sheet and the base sheet of one preferred embodiment of the present invention;

FIG. 3 is a schematic front view of the assembly of the electrical connector of one preferred embodiment of the present invention;

FIG. 4 is a schematic view illustrating the electrical connector of one preferred embodiment of the present invention being connected with an electrical card;

FIG. 5 is a schematic exploded view of the electrical connector of another preferred embodiment of the present invention;

FIG. 6a is a schematic front partially-enlarged view illustrating the buckling sheet and the base sheet of another preferred embodiment of the present invention;

FIG. 6b is a schematic rear partially-enlarged view illustrating the buckling sheet and the base sheet of another preferred embodiment of the present invention;

FIG. 7 is a schematic view illustrating the electrical connector of another preferred embodiment of the present invention being connected with an electrical card;

FIG. 8 is a schematic exploded view of the electrical connector of one another preferred embodiment of the present invention;

FIG. 9 is a schematic partially-enlarged view illustrating the buckling sheet and the base sheet of one another preferred embodiment of the present invention;

FIG. 10 is a schematic view illustrating the electrical connector of one another preferred embodiment of the present invention being connected with an electrical card.

### DETAILED DESCRIPTION OF THE PREFERRED EMBODIMENT

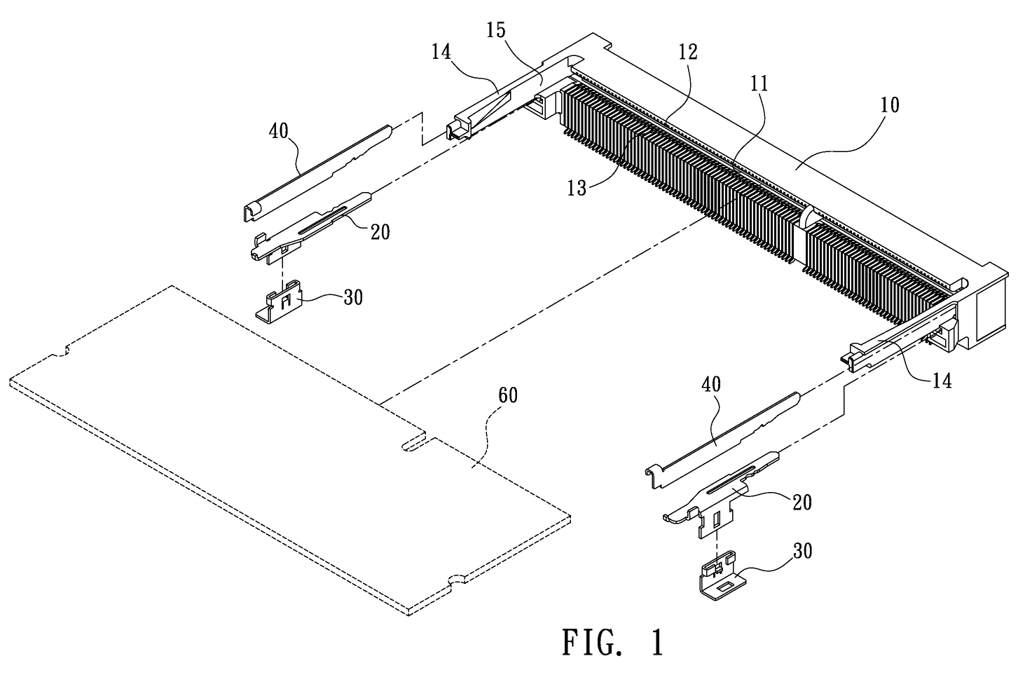

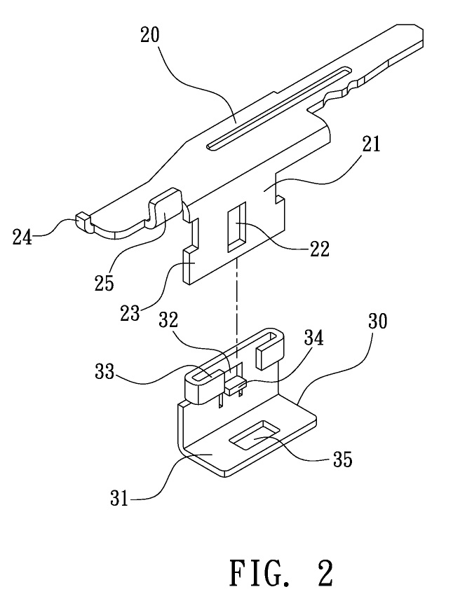

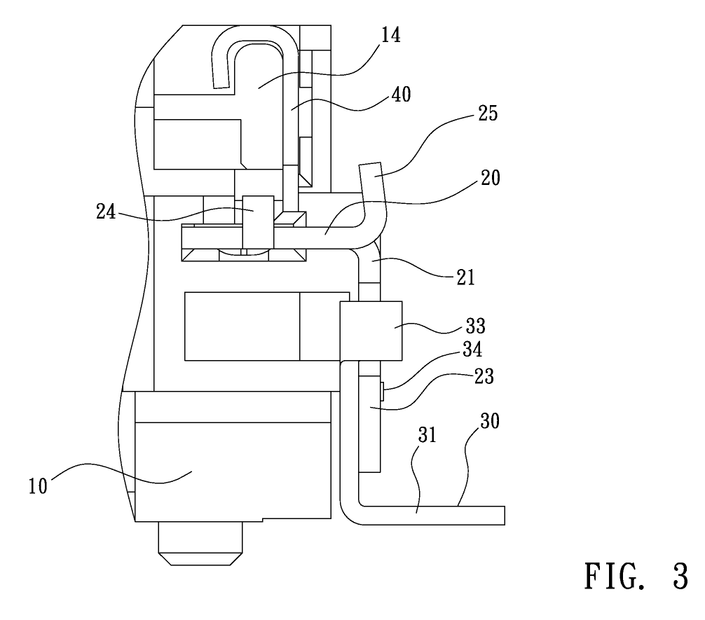

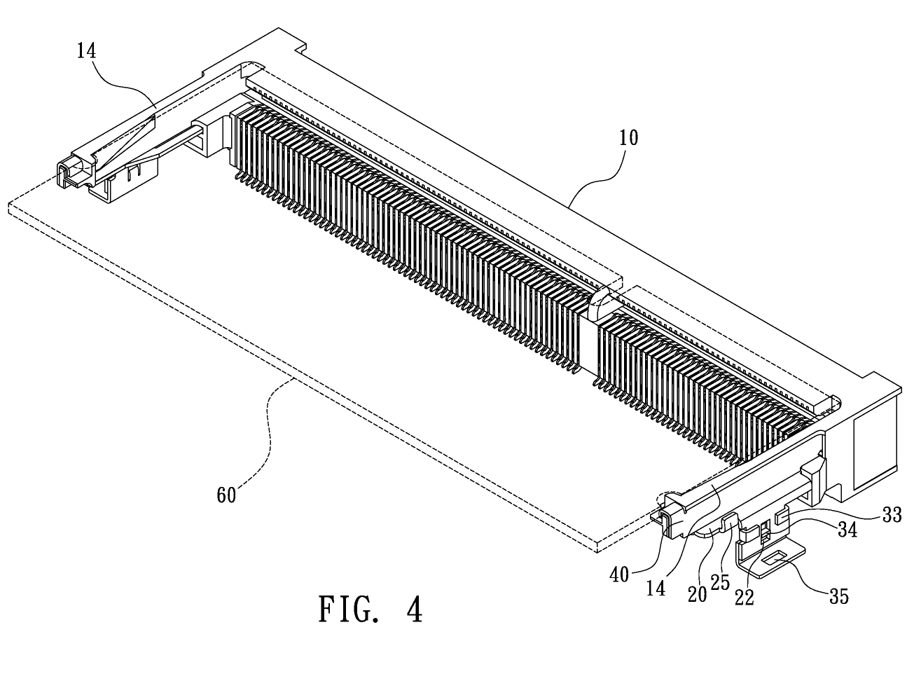

Referring from FIG. 1 to FIG. 4, wherein FIG. 1 is a schematic exploded view of the electrical connector of one preferred embodiment of the present invention; FIG. 2 is a schematic partially-enlarged view illustrating the buckling sheet and the base sheet of one preferred embodiment of the present invention; FIG. 3 is a schematic front view of the assembly of the electrical connector of one preferred embodiment of the present invention; FIG. 4 is a schematic view illustrating the electrical connector of one preferred embodiment of the present invention being connected with an electrical card.

As shown in figures, the electrical connector provided by the present invention comprises: an insulation housing 10; a buckling sheet 20; and a base sheet 30.

The insulation housing 10 is made of, e.g. but not limited to, plastic material, and has an insertion slot 11 for receiving an electrical card 60, the insertion slot 11 is installed with a plurality of first conduction terminals 12 and a plurality of second conduction terminals 13 that are arranged with an up/down means relative to the first conduction terminals 12. Two ends of the insulation housing 10 are respectively installed with a resilient arm 14 having a guiding slot 15 for guiding the electrical card 60 to be inserted in the insertion slot 11. The electrical card 60 is, e.g. but not limited to, a DIMM card, the plural first conduction terminals 12 and the plural second conduction terminals 13 are conventional arts therefore no further illustration is provided.

The buckling sheet 20 is made of metal material, e.g. but not limited to stainless steel, and is able to be connected to the insulation housing 10 and disposed below the resilient arm 14, an extending sheet 21 having a buckling hole 22 is downwardly extended from the buckling sheet 20, at least one end of the extending sheet 21 is installed with a protruding sheet 23; in this embodiment, for illustration, two ends of the extending sheet 21 are respectively installed with a protruding sheet 23. The buckling sheet 20 is further installed with a first positioning portion 24 and a second positioning portion 25, wherein the first positioning portion 24 is, e.g. but not limited to, disposed in front of the buckling sheet 20 and the second positioning portion 25 is, e.g. but not limited to, disposed at the right side of the buckling sheet 20.

The base sheet 30 is made of metal material, e.g. but not limited to stainless steel, and has a fastening member 31, a base hole 32 and at least one folded hooking sheet 33; wherein the position where the base hole 32 is installed is with respect to the buckling hole 22, and a limiting sheet 34 is installed in the base hole 32, the limiting sheet 34 is upwardly extended from the bottom end of the base hole 32 and the distal end thereof is in a bended status, e.g. but not limited to an inward-90-degree bended status; the limiting sheet 34 is not resilient, and functions provided by the limiting sheet 34 are reinforcing the stability of the base sheet 30 for lowering left/right oblique angles thereof. In a primary processing, the folded hooking sheet 33 is outwardly extended and is parallel to the base sheet 30, and after being disposed in a gap defined above the protruding sheet 23, the folded hooking sheet 33 is subject to a secondary processing to be inwardly bended for limiting and positioning the base sheet 30, in this embodiment, for illustration, two ends of the base sheet 30 are respectively installed with a folded hooking sheet 33. The fastening member 31 is bended so as to be vertical to the base sheet 30, and is further installed with a fastening hole 35 for being connected to a substrate (not shown) through a soldering means, wherein said substrate is, e.g. but not limited to, a computer mother board.

The electrical connector provided by the present invention is further installed with a reinforcing sheet 40, which is able to be connected to the insulation housing 10 and disposed between the first positioning portion 24 and the second positioning portion 25 of the buckling sheet 20, for reinforcing the strength of the resilient arm 14, and the reinforcing sheet 40 is left/right positioned through the first positioning portion 24 and the second positioning portion 25.

As shown in FIG. 3, when being assembled, the buckling sheet 20 and the reinforcing sheet 40 are installed in the insulation housing 10, then the limiting sheet 34 is installed in the buckling hole 22, the folded hooking sheet 33 is installed at the gap defined above the protruding sheet 23, then the folded hooking sheet 33 is inwardly bended with the secondary processing means so that the base sheet 30 is fastened on the buckling sheet 20, because there are a slit defined when the limiting sheet 34 is installed in the buckling hole 22, the position of the base sheet 30 is able to be longitudinally adjusted then solder is filled in the fastening hole 35, so that the electrical connector is able to be stably soldered on the substrate to ensure the soldering stability of the electrical connector. Therefore, the electrical connector provided by the present invention is able to be finely adjusted, according to the deformed height of the insulation housing 10, so as to stably solder the electrical connector on a substrate.

As shown in FIG. 4, when the electrical card 60 is desired to be inserted in the electrical connector, the electrical card 60 is obliquely inserted in the guiding slot 15 with a certain oblique angle, then the electrical card 60 is inserted and fastened in the insertion slot 11 through the guiding slot 15, so the connection of the electrical connector provided by the present invention and the electrical card 60 is finished. When the electrical card 60 is desired to be removed from the electrical connector, the reinforcing sheet 40 is outwardly pulled to the second positioning portion 25, so the electrical card 60 and the insertion slot 11 are preliminarily separated, then a force is applied to remove the electrical card 60 from the insertion slot 11 along the guiding slot 15, therefore the separation of the electrical connector provided by the present invention and the electrical card 60 is finished.

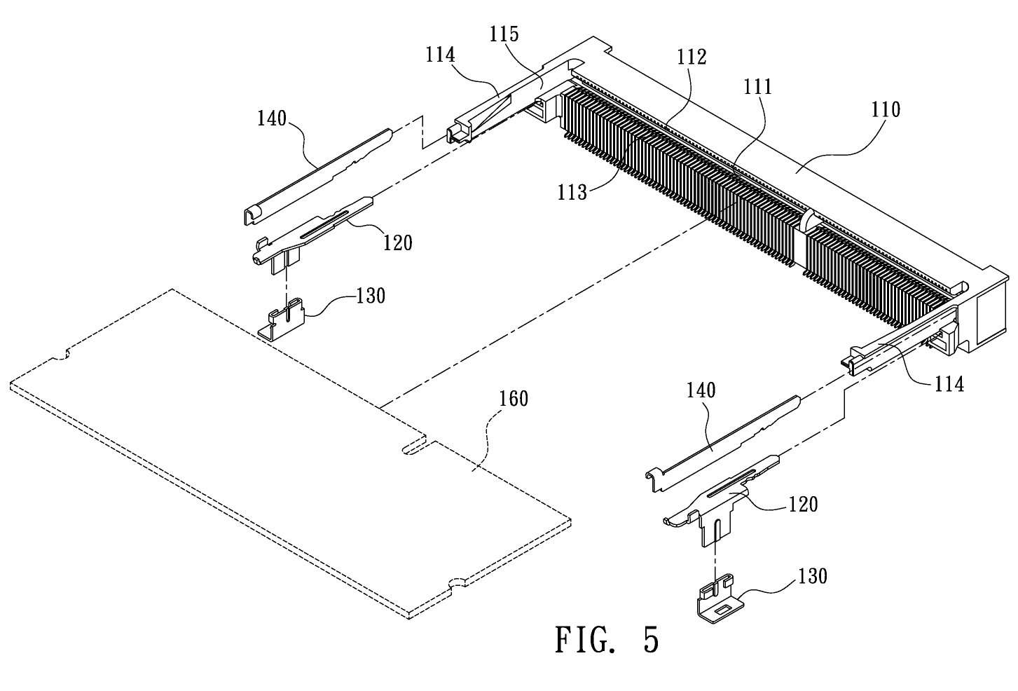

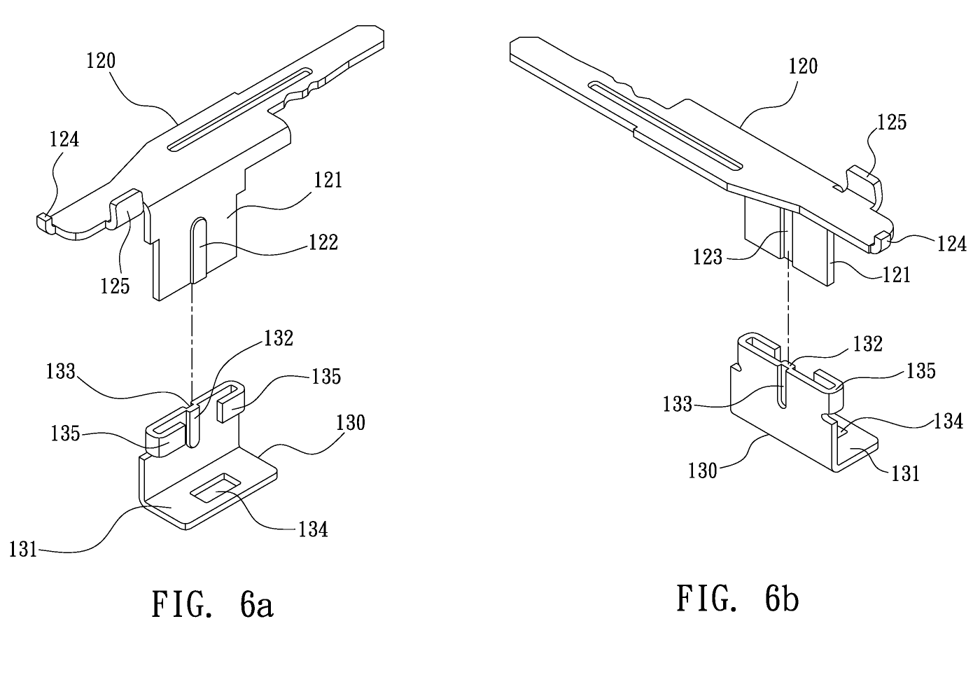

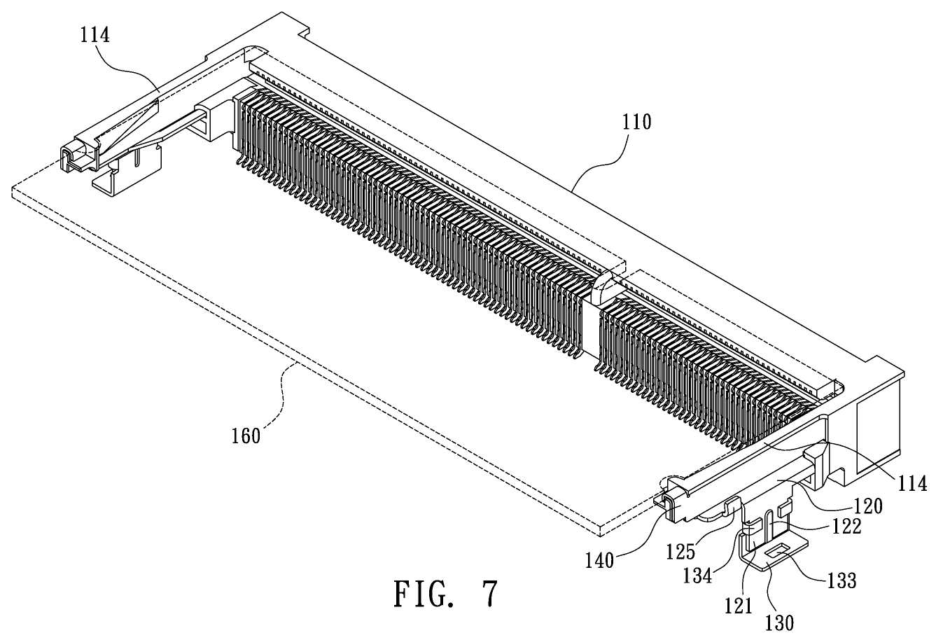

Referring from FIG. 5 to FIG. 7, wherein FIG. 5 is a schematic exploded view of the electrical connector of another preferred embodiment of the present invention; FIG. 6a is a schematic front partially-enlarged view illustrating the buckling sheet and the base sheet of another preferred embodiment of the present invention; FIG. 6b is a schematic rear partially-enlarged view illustrating the buckling sheet and the base sheet of another preferred embodiment of the present invention; FIG. 7 is a schematic view illustrating the electrical connector of another preferred embodiment of the present invention being connected with an electrical card.

As shown in figures, the electrical connector of another preferred embodiment of the present invention comprises: an insulation housing 110; a buckling sheet 120; and a base sheet 130.

The insulation housing 110 is made of, e.g. but not limited to, plastic material, and has an insertion slot 111 for receiving an electrical card 160, the insertion slot 111 is installed with a plurality of first conduction terminals 112 and a plurality of second conduction terminals 113 that are arranged with an up/down means relative to the first conduction terminals 112. Two ends of the insulation housing 110 are respectively installed with a resilient arm 114 having a guiding slot 115 for guiding the electrical card 160 to be inserted in the insertion slot 111. The electrical card 160 is, e.g. but not limited to, a DIMM card, the plural first conduction terminals 112 and the plural second conduction terminals 113 are conventional arts therefore no further illustration is provided.

The buckling sheet 120 is made of metal material, e.g. but not limited to stainless steel, and is able to be connected to the insulation housing 110 and disposed below the resilient arm 114, an extending sheet 121 is downwardly extended from the buckling sheet 120, a first protruding portion 122 is longitudinally installed on the extending sheet 121, and a first concave slot 123 is formed on the back side of the first protruding portion 122. The buckling sheet 120 is further installed with a first positioning portion 124 and a second positioning portion 125, wherein the first positioning portion 124 is, e.g. but not limited to, disposed in front of the buckling sheet 120 and the second positioning portion 125 is, e.g. but not limited to, disposed at the right side of the buckling sheet 120.

The base sheet 130 is made of metal material, e.g. but not limited to stainless steel, and has a fastening member 131 and a second protruding portion 132, the back side of the second protruding portion 132 is formed with a second concave slot 133, wherein the position where the second protruding portion 132 is formed is with respect to the first concave slot 123, so when the second protruding portion 132 is installed in the first concave slot 123, the position of the base sheet 130 is able to be longitudinally adjusted so as to stably solder the fastening member 131 on a substrate. The fastening member 131 is bended so as to be vertical to the base sheet 130, and is further installed with a fastening hole 134 for connecting to the substrate (not shown) with a soldering means, wherein the substrate is, e.g. but not limited to, a computer mother board.

The ends of the base sheet 130 are respectively installed with a folded hooking sheet 135 serving to further fasten the extending sheet 121 after being inwardly bended, the function thereof are the same as what is disclosed in the previous embodiment.

The electrical connector provided by the present invention is further installed with a reinforcing sheet 140, which is able to be connected to the insulation housing 110 and disposed between the first positioning portion 124 and the second positioning portion 125 of the buckling sheet 120, for reinforcing the strength of the resilient arm 114, and the reinforcing sheet 140 is left/right positioned through the first positioning portion 124 and the second positioning portion 125.

As shown in FIG. 7, when being assembled, the buckling sheet 120 and the reinforcing sheet 140 are installed in the insulation housing 110, then the base sheet 130 is installed with a means of from bottom to top so that the second protruding portion 132 of the base sheet 130 is installed in the first concave slot 123, because there is a small space allowing the second protruding portion 132 to move in the first concave slot 123, the position of the base sheet 130 is able to be longitudinally adjusted, and after the position of the base sheet 130 is fixed, the folded hooking sheet 135 is installed on the extending sheet 121 and two ends thereof are inwardly bended for fastening the buckling sheet 120, lastly solder is filled in the fastening hole 134 so that the electrical connector is stably soldered on the substrate to ensure the soldering stability of the electrical connector. Therefore, the electrical connector provided by the present invention is able to be finely adjusted, according to the deformed height of the insulation housing 10, so as to stably solder the electrical connector on a substrate.

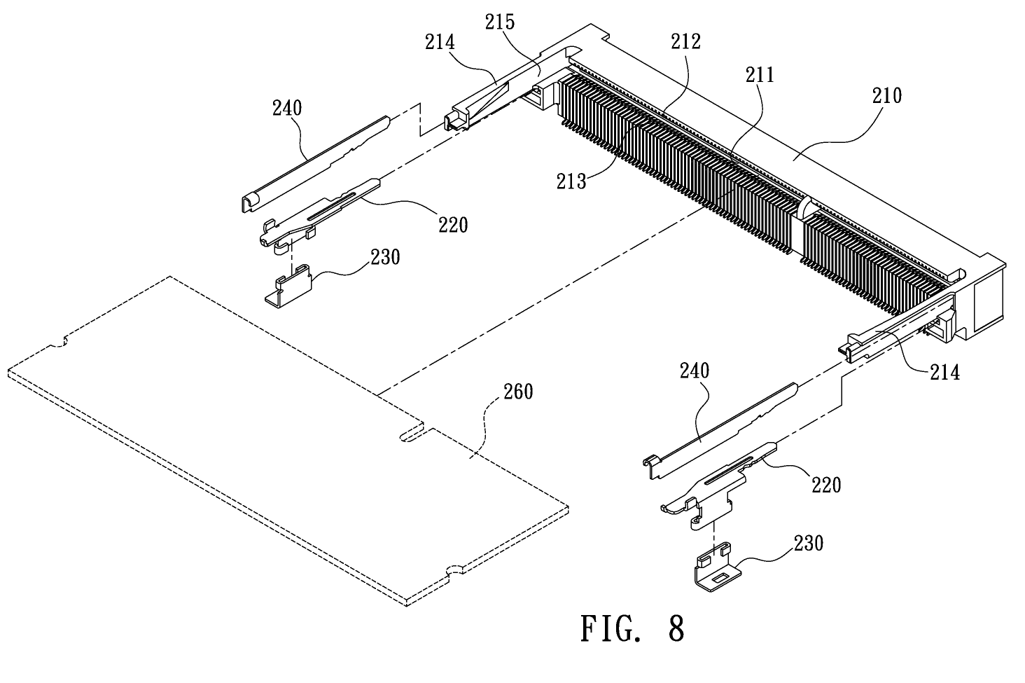

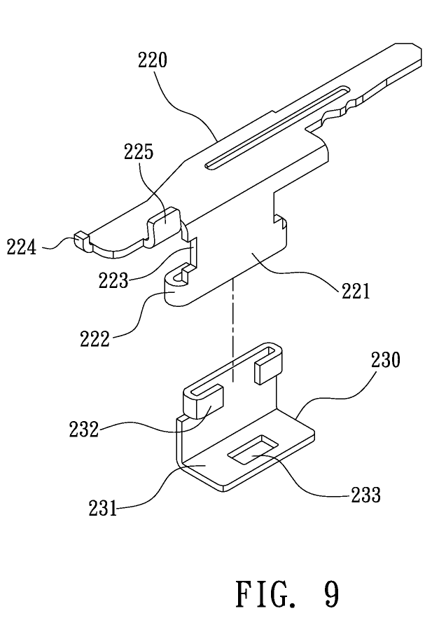

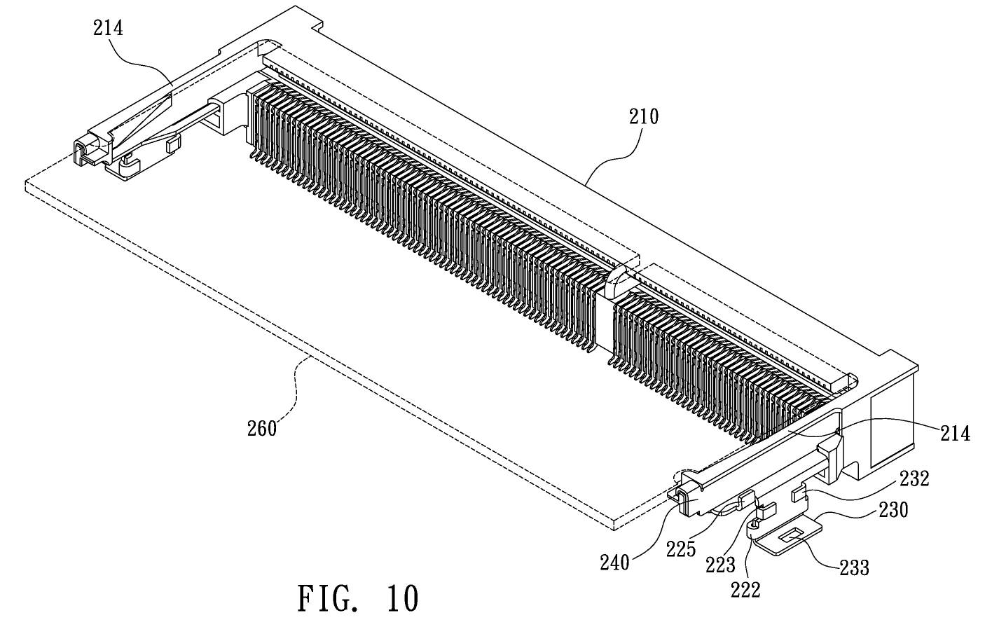

Referring to FIG. 8 to FIG. 10, wherein FIG. 8 is a schematic exploded view of the electrical connector of one another preferred embodiment of the present invention; FIG. 9 is a schematic partially-enlarged view illustrating the buckling sheet and the base sheet of one another preferred embodiment of the present invention; FIG. 10 is a schematic view illustrating the electrical connector of one another preferred embodiment of the present invention being connected with an electrical card.

As shown in figures, the electrical connector of one another preferred embodiment of the present invention comprises: an insulation housing 210; a buckling sheet 220; and a base sheet 230.

The insulation housing 210 is made of, e.g. but not limited to, plastic material, and has an insertion slot 211 for receiving an electrical card 260, the insertion slot 211 is installed with a plurality of first conduction terminals 212 and a plurality of second conduction terminals 213 that are arranged with an up/down means relative to the first conduction terminals 212. Two ends of the insulation housing 210 are respectively installed with a resilient arm 214 having a guiding slot 215 for guiding the electrical card 260 to be inserted in the insertion slot 211. The electrical card 260 is, e.g. but not limited to, a DIMM card, the plural first conduction terminals 212 and the plural second conduction terminals 213 are conventional arts therefore no further illustration is provided.

The buckling sheet 220 is made of metal material, e.g. but not limited to stainless steel, and is able to be connected to the insulation housing 210 and disposed below the resilient arm 214, an extending sheet 221 is downwardly extended from the buckling sheet 220, at least one end of the extending sheet 221 is installed with a first folded hooking sheet 222, a top end of the first folded hooking sheet 222 is installed with a sheet gap 223; in this embodiment, for illustration, two ends of the extending sheet 221 are respectively installed with a first folded hooking sheet 222. The buckling sheet 220 is further installed with a first positioning portion 224 and a second positioning portion 225, wherein the first positioning portion 224 is, e.g. but not limited to, disposed in front of the buckling sheet 220 and the second positioning portion 225 is, e.g. but not limited to, disposed at the right side of the buckling sheet 220. In a primary processing, the first folded hooking sheet 222 is outwardly extended and in parallel to the buckling sheet 220; in a secondary processing, the first folded hooking sheet 222 is outwardly bended.

The base sheet 230 is made of metal material, e.g. but not limited to stainless steel, and has a fastening member 231 and at least one second folded hooking sheet 232, wherein the orientation and position where the second folded hooking sheet 232 is installed are opposite and staggered with respect to the first folded hooking sheet 222. The fastening member 231 is bended so as to be vertical to the base sheet 230, and is further installed with a fastening hole 233 for connecting to a substrate (not shown) with a soldering means, wherein the substrate is, e.g. but not limited to, a computer mother board. In a primary processing, the second folded hooking sheet 232 is outwardly extended and in parallel to the base sheet 230; in a secondary processing, the second folded hooking sheet 232 is inwardly bended.

The electrical connector provided by the present invention is further installed with a reinforcing sheet 240, which is able to be connected to the insulation housing 210 and disposed between the first positioning portion 224 and the second positioning portion 225 of the buckling sheet 220, for reinforcing the strength of the resilient arm 214, and the reinforcing sheet 240 is left/right positioned through the first positioning portion 224 and the second positioning portion 225.

As shown in FIG. 10, when being assembled, the buckling sheet 220 and the reinforcing sheet 240 are installed in the insulation housing 210, then the second folded hooking sheet 232 is installed in the sheet gap 223 and is inwardly bended; because a slit is defined in the sheet gap 223, the position of the base sheet 230 is able to be longitudinally adjusted, after the position of the base sheet 230 is fixed, the first folded hooking sheet 222 is reversely covered the base sheet 230 and is outwardly bended for fastening the buckling sheet 220, so the base sheet 230 is fastened on the buckling sheet 220, lastly solder is filled in the fastening hole 233 so that the electrical connector is stably soldered on the substrate to ensure the soldering stability of the electrical connector. Therefore, the electrical connector provided by the present invention is able to be finely adjusted, according to the deformed height of the insulation housing 210, so as to stably solder the electrical connector on a substrate. Thus, the electrical connector provided by the present invention is novel comparing to conventional electrical connectors.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector, comprising:
an insulation housing having an insertion slot for receiving an electrical card, the insertion slot being installed with a plurality of first conduction terminals and a plurality of second conduction terminals arranged with the first conduction terminals with an up/down means, two ends of the insulation housing being respectively installed with a resilient arm having a guiding slot for guiding the electrical card to be inserted in the insertion slot;
a buckling sheet connected to the insulation housing and installed below the resilient arm, an extending sheet being downwardly extended from the buckling sheet, at least one end of the extending sheet is installed with a protruding sheet; and
a base sheet having a fastening member and at least one folded hooking sheet, wherein when the folded hooking sheet is installed and fastened on top of the extending sheet, the position of the base sheet is longitudinally adjusted so as to stably solder the fastening sheet on a substrate.

2. The electrical connector as claimed in claim 1, wherein the insulation housing is made of plastic material, the buckling sheet and the base sheet are made of metal material, the electrical card is a DIMM card.

3. The electrical connector as claimed in claim 1, wherein further being installed with a reinforcing sheet, and the buckling sheet is further installed with a first positioning portion and a second positioning portion for reinforcing the left/right limitation for the reinforcing sheet, the reinforcing sheet is connected to the insulation housing and is disposed between the first positioning portion and the second positioning portion of the buckling sheet, wherein the first positioning portion is disposed in front of the buckling sheet, the second positioning portion is disposed at the right side of the buckling sheet.

4. The electrical connector as claimed in claim 1, wherein the extending sheet is installed with a buckling hole, the base sheet is installed with a base hole, the position where the base hole is installed is with respect to the buckling hole, and a limiting sheet is installed in the base hole.

5. The electrical connector as claimed in claim 4, wherein two ends of the extending sheet are respectively installed with a protruding sheet, two ends of the base sheet are respectively installed with a folded hooking sheet, when the folded hooking sheet is installed and fastened on top of the extending sheet, the limiting sheet is disposed in the buckling hole for reinforcing the stability of the base sheet and for reducing the oblique angle of the base sheet.

6. The electrical connector as claimed in claim 1, wherein the fastening member is bended so as to be vertical to the base sheet, and is further installed with a fastening hole for being connected to the substrate through soldering.

7. The electrical connector as claimed in claim 4, wherein the limiting sheet is upwardly extended from the bottom end of the base hole and the distal end thereof is in a bended status.

8. An electrical connector, comprising:
an insulation housing having an insertion slot for receiving an electrical card, the insertion slot is installed with a plurality of first conduction terminals and a plurality of second conduction terminals arranged with the first conduction terminals with an up/down means, two ends of the insulation housing are respectively installed with a resilient arm having a guiding slot for guiding the electrical card to be inserted in the insertion slot;
a buckling sheet connected to the insulation housing and installed below the resilient arm, an extending sheet is downwardly extended from the buckling sheet, the extending sheet is installed with a first protruding portion, a first concave slot is formed at the back side of the first protruding portion; and
a base sheet having a fastening member and a second protruding portion, a second concave slot is formed at the back side of the second protruding portion, wherein the position where the second protruding portion is installed is with respect to the first concave slot, when the second protruding portion is installed in the first concave slot, the position of the base sheet is longitudinally adjusted so as to stably solder the fastening sheet on a substrate.

9. The electrical connector as claimed in claim 8, wherein the insulation housing is made of plastic material, and the electrical card is a DIMM card.

10. The electrical connector as claimed in claim 8, wherein further being installed with a reinforcing sheet, and the buckling sheet is further installed with a first positioning portion and a second positioning portion for reinforcing the left/right limitation for the reinforcing sheet, the reinforcing sheet is connected to the insulation housing and is disposed between the first positioning portion and the second positioning portion of the buckling sheet, wherein the first positioning portion is disposed in front of the buckling sheet, the second positioning portion is disposed at the right side of the buckling sheet.

11. The electrical connector as claimed in claim 8, wherein the buckling sheet and the base sheet are made of metal material.

12. The electrical connector as claimed in claim 8, wherein two ends of the base sheet are installed with a folded hooking sheet for fastening the extending sheet.

13. The electrical connector as claimed in claim 8, wherein the fastening member is bended so as to be vertical to the base sheet, and is further installed with a fastening hole for being connected to the substrate through soldering.

14. An electrical connector, comprising:
an insulation housing having an insertion slot for receiving an electrical card, the insertion slot is installed with a plurality of first conduction terminals and a plurality of second conduction terminals arranged with the first conduction terminals with an up/down means, two ends of the insulation housing are respectively installed with a resilient arm having a guiding slot for guiding the electrical card to be inserted in the insertion slot;
a buckling sheet connected to the insulation housing and installed below the resilient arm, an extending sheet is downwardly extended from the buckling sheet, at least one end of the extending sheet is installed with a first folded hooking sheet having a sheet gap on the top end; and
a base sheet having a fastening member and at least one second folded hooking sheet, wherein the position where the second folded hooking sheet is installed is staggered with respect to the first folded hooking sheet and the orientation thereof is opposite to the first folded hooking sheet, when the second folded hooking sheet is installed in the sheet gap, the position of the base sheet is longitudinally adjusted, and the first folded hooking sheet is reversely covered the base sheet, so the fastening member is stably soldered on a substrate.

15. The electrical connector as claimed in claim 14, wherein the insulation housing is made of plastic material, and the electrical card is a DIMM card.

16. The electrical connector as claimed in claim 14, wherein further being installed with a reinforcing sheet, and the buckling sheet is further installed with a first positioning portion and a second positioning portion for reinforcing the left/right limitation for the reinforcing sheet, the reinforcing sheet is connected to the insulation housing and is disposed between the first positioning portion and the second positioning portion of the buckling sheet, wherein the first positioning portion is disposed in front of the buckling sheet, the second positioning portion is disposed at the right side of the buckling sheet.

17. The electrical connector as claimed in claim 14, wherein the buckling sheet and the base sheet are made of metal material.

18. The electrical connector as claimed in claim 14, wherein the fastening member is bended so as to be vertical to the base sheet, and is further installed with a fastening hole for being connected to the substrate through soldering.
